(19) United States
(12) Patent Application Publication
(10) Pub. No.: US 2008/0247078 A1
(43) Pub. Date: Oct. 9, 2008

(54) Altitude sensing systems and methods for fly height adjustment

(75) Inventors: MingGao Yao, Dongguan (CN); Lin Guo, Dongguan (CN); Yu Sun, Dongguan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K) Ltd., Hong Kong (CN)

(21) Appl. No.: 11/783,183

(22) Filed: Apr. 6, 2007

(51) Int. Cl. G11B 21/02

(52) U.S. Cl. 360/75

(57) ABSTRACT

Altitude sensing systems and/or methods for fly height adjustment in disk drive devices are provided. In certain example embodiments, a PZT-type pressure and/or altitude sensor may be located on the side of the disk drive proximate to the disk edge. When the disk rotates, the air flow generated by the disk will deform the PZT element of the sensor. The PZT element will generate a voltage in response to this deformation. Calibrations may be performed to compensate for altitude changes (e.g. the air inside of the disk drive will become thin and the air resistance will be reduced at higher altitudes). Also, the output sensitivity of the PZT element may change with the altitude change. After the altitude is sensed by the PZT element in the sensor, the servo motor may use this signal to calculate and/or adjust the dynamic fly height (DFH) and/or fly height of the read/write head.

### FIELD OF THE INVENTION

The example embodiments herein relate to information recording disk drive devices and, more particularly, to altitude sensing systems and/or methods for fly height adjustment in disk drive devices.

### BACKGROUND OF THE INVENTION

One known type of information storage device is a disk drive device that uses magnetic media to store data and a movable read/write head that is positioned over the media to selectively read from or write to the disk.

Consumers are constantly desiring greater storage capacity for such disk drive devices, as well as faster and more accurate reading and writing operations. Thus, disk drive manufacturers have continued to develop higher capacity disk drives by, for example, increasing the density of the information tracks on the disks by using a narrower track width and/or a narrower track pitch. However, each increase in track density requires that the disk drive device have a corresponding increase in the positional control of the read/write head in order to enable quick and accurate reading and writing operations using the higher density disks. As track density increases, it becomes more and more difficult using known technology to quickly and accurately position the read/write head over the desired information tracks on the storage media. Thus, disk drive manufacturers are constantly seeking ways to improve the positional control of the read/write head in order to take advantage of the continual increases in track density.

One approach that has been effectively used by disk drive manufacturers to improve the positional control of read/write heads for higher density disks is to employ a secondary actuator, known as a micro-actuator, that works in conjunction with a primary actuator to enable quick and accurate positional control for the read/write head. Disk drives that incorporate micro-actuators are known as dual-stage actuator systems.

Various dual-stage actuator systems have been developed in the past for the purpose of increasing the access speed and fine tuning the position of the read/write head over the desired tracks on high density storage media. Such dual-stage actuator systems typically include a primary voice-coil motor (VCM) actuator and a secondary micro-actuator, such as a PZT element micro-actuator. The VCM actuator is controlled by a servo control system that rotates the actuator arm that supports the read/write head to position the read/write head over the desired information track on the storage media. The PZT element micro-actuator is used in conjunction with the VCM actuator for the purpose of increasing the positioning access speed and fine tuning the exact position of the read/write head over the desired track. Thus, the VCM actuator makes larger adjustments to the position of the read/write head, while the PZT element micro-actuator makes smaller adjustments that fine tune the position of the read/write head relative to the storage media. In conjunction, the VCM actuator and the PZT element micro-actuator enable information to be efficiently and accurately written to and read from high density storage media.

One known type of micro-actuator incorporates PZT elements for causing fine positional adjustments of the read/write head. Such PZT micro-actuators include associated electronics that are operable to excite the PZT elements on the micro-actuator to selectively cause expansion and/or contraction thereof. The PZT micro-actuator is configured such that expansion and/or contraction of the PZT elements causes movement of the micro-actuator which, in turn, causes movement of the read/write head. This movement is used to make faster and finer adjustments to the position of the read/write head, as compared to a disk drive unit that uses only a VCM actuator. Exemplary PZT micro-actuators are disclosed in, for example, JP 2002-133803; U.S. Pat. Nos. 6,671,131 and 6,700,749; and U.S. Publication No. 2003/0168935, the contents of each of which are incorporated herein by reference.

FIG. 1a illustrates a conventional disk drive unit and show a magnetic disk 101 mounted on a spindle motor 102 for spinning the disk 101. A voice coil motor arm 104 carries a head gimbal assembly (HGA) that includes a micro-actuator 105 with a slider incorporating a read/write head 103. A voice-coil motor (VCM) is provided for controlling the motion of the motor arm 104 and, in turn, controlling the slider to move from track to track across the surface of the disk 101, thereby enabling the read/write head 103 to read data from or write data to the disk 101.

Because of the inherent tolerances (e.g., dynamic play) of the VCM and the head suspension assembly, the slider cannot achieve quick and fine position control, which adversely impacts the ability of the read/write head to accurately read data from and write data to the disk when only a servo motor system is used. As a result, a PZT micro-actuator 105, as described above, is provided in order to improve the positional control of the slider and the read/write head 103. More particularly, the PZT micro-actuator 105 corrects the displacement of the slider on a much smaller scale, as compared to the VCM, in order to compensate for the resonance tolerance of the VCM and/or head suspension assembly. The micro-actuator enables, for example, the use of a smaller recording track pitch, and can increase the “tracks-per-inch” (TPI) value for the disk drive unit, as well as provide an advantageous reduction in the head seeking and settling time. Thus, the PZT micro-actuator 105 enables the disk drive device to have a significant increase in the surface recording density of the information storage disks used therein.

These refinements have focused on finely tuned horizontal displacement to accommodate the rapid increase in disk drive capacity. Similarly, rapidly increasing the capacity also requires that the height at which the head flies over the magnetic media be controlled with more and more sensitivity. Accordingly, an acceleration sensor and/or pressure sensor has been provided between the suspension dimple and the flexure of an HGA as disclosed, for example, in JP 2005-093055, the entire contents of which are incorporated herein by reference. When the head fly height changes, the acceleration sensor and/or the PZT sensor will detect the pressure between the dimple and the flexure and generate an electrical potential voltage in response thereto. From this signal, the servo will adjust and/or compensate for the changes in fly height.

FIG. 1b is a sensor for detecting fly height in the prior art. An acceleration sensor or pressure sensor 115 is a laminated structure, located between the dimple 112 formed on the load beam 111 and the slider 100. The sensor 115 includes a piezoelectric crystal layer 119. The first and second conductor layers 118 and 120 are formed on both sides of the piezoelectric crystal layer 119. A first insulator layer 117 is disposed between the first conductor layer 118 and the metal layer 116 (which may contact dimple 112). A second insulator layer 121 may be disposed between the second conductor layer 120 and the slider 100. When head-disk interface (HDI) occurs, the acceleration sensor or pressure sensor 115 will be pressured, generating an electrical potential voltage of several millivolt. Based on this signal, the servo will adjust and/or compensate the fly height.

Unfortunately, this technique suffers several drawbacks. For example, because of size constraints, the sensitivity to fly height changes is limited. Also, the amount of sensitivity frequently changes when an environmental condition changes. Thus, for example, as the altitude changes, the sensitivity of the altitude measurement also changes, which challenges the servo control system to account both for the change in height and in the change in height measurement sensitivity. Moreover, prior techniques provide a PZT element between the suspension flexure and the dimple, which may make it is easy to damage the PZT element during dimple and flexure interference (e.g. when a shock or vibration occurs, etc.). This interference may generate fragments or particles, which may, in turn, contaminate the head-disk interface and affect the head read and write functions. In the long-term, these drawbacks result in reliability concerns. Additionally, the manufacturing process is difficult and costly.

Thus it will be appreciated that there is a need in the art for altitude sensing systems and/or methods for fly height adjustment in disk drive devices.

### SUMMARY OF THE INVENTION

One aspect of certain example embodiments described herein relates to a sensor unit capable of providing data relating to the fly height of the head over the disk.

Another aspect of certain example embodiments described herein relates to a sensor unit that need not be located between the dimple and the flexure of a support arm.

A further aspect of certain example embodiments described herein relates to a sensor unit mounted proximate to the disk edge, proximate to the flex cable, on the top of the VCM arm, to the side of the VCM arm, etc.

According to certain example embodiments, an altitude sensor configured to detect an air flow windage generated by a component of a system is provided. A beam may be configured to move in response to the air flow windage. At least one PZT layer may be formed on a surface of the beam. The at least one PZT layer may be configured to generate a voltage corresponding to a movement of the beam. At least one connection pad may be operably coupled to the at least one PZT layer. The at least one connection pad may be suitable for outputting the voltage. The air flow windage may be related to altitude.

In certain example embodiments, an altitude sensor for use in a disk drive device is provided. A beam may be configured to move in response to an air flow generated by a rotating disk. At least one PZT layer may be formed on a surface of the beam. The at least one PZT layer may be configured to generate a voltage corresponding to a movement of the beam. At least one connection pad may be operably coupled to the at least one PZT layer. The at least one connection pad may be suitable for outputting the voltage.

In certain other example embodiments, a disk drive device is provided. Such disk drive devices may comprise a head gimbal assembly. A drive arm may be connected to the head gimbal assembly. The head gimbal assembly may include a slider having a read/write head formed thereon. Such disk drive devices also may comprise a disk. A spindle motor may be operable to spin the disk. The disk may cause an air flow when spun. An altitude sensor may be provided, which may include a beam configured to move in response to the air flow. At least one PZT layer may be formed on a surface of the beam. The at least one PZT layer may be configured to generate a voltage corresponding to a movement of the beam. At least one connection pad may be operably coupled to the at least one PZT layer. The at least one connection pad may be suitable for outputting the voltage.

In still further example embodiments, a method of determining dynamic fly height of a read/write head flying over a disk is provided. A signal corresponding to air flow caused by rotation of the disk may be generated. The signal may be associated with a dynamic fly height based at least in part on an altitude of the read/write head. Optionally, the signal and the fly height may be associated using a Fast Fourier Transform. Also optionally, the dynamic fly height may be changed based at least in part on the altitude.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1a is a partial perspective view of a conventional disk drive unit;

FIG. 1b is a sensor for detecting fly height in the prior art;

FIG. 2a is a hard disk drive device having a fly height sensor, in accordance with an example embodiment;

FIG. 2b is a detailed view of the connector of FIG. 2a, in accordance with an example embodiment;

FIG. 3a is a detailed exploded view of a sensor unit, in accordance with an example embodiment;

FIG. 3b is a view of the sensor unit of FIG. 3a when assembled, in accordance with an example embodiment;

FIG. 3c illustrates the operational concept of the sensor of FIGS. 3a and 3b;

FIG. 3d is a side view of a first illustrative moving beam of FIGS. 3a-c, in accordance with an example embodiment;

FIG. 3e is a side view of a second illustrative moving beam of FIGS. 3a-c, in accordance with an example embodiment;

FIGS. 4a and 4b show testing data for an example embodiment;

FIG. 5a plots sensor output vs. altitude for a simulation of an example embodiment;

FIG. 5b plots head fly height vs. altitude for another simulation of an example embodiment;

FIG. 6a is an illustrative flowchart showing a process for adjusting the head fly height using the altitude sensor, in accordance with an example embodiment;

FIG. 6b is an illustrative flowchart showing a process for calculating how the head fly height should be adjusted, in accordance with an example embodiment;

FIG. 7 shows an example embodiment where the altitude sensor is laid horizontally;

FIG. 8a shows another example embodiment where the altitude sensor is mounted to the top of the VCM arm;

FIG. 8b is a detailed view of the arm of FIG. 8a; and,

FIG. 9 is yet another example embodiment in which the sensor unit 901 is mounted to the side of the VCM arm.

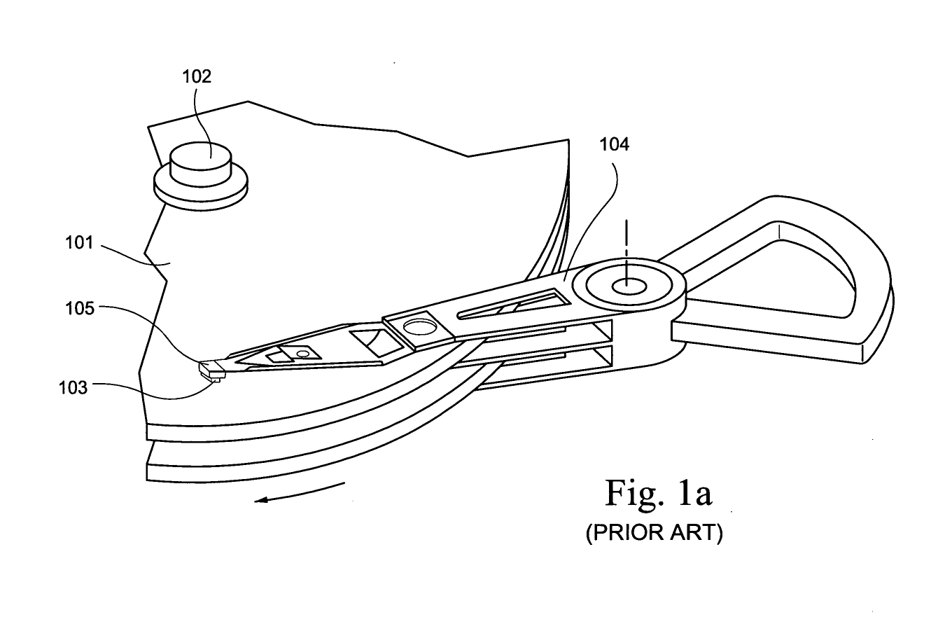

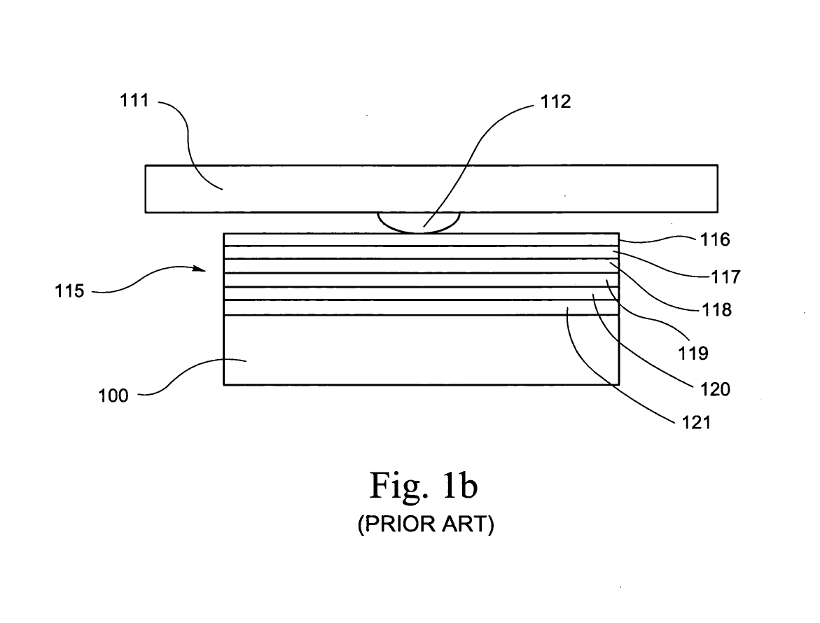

### DETAILED DESCRIPTION OF ILLUSTRATED EMBODIMENTS

According to certain example embodiments, a PZT-type pressure and/or altitude sensor may be located on the side of the disk drive proximate to the disk edge. When the disk rotates, the air flow generated by the disk will deform the PZT element of the sensor. The PZT element will generate a voltage in response to this deformation. Calibrations may be performed to compensate for altitude changes (e.g. the air inside of the disk drive will become thin and the air resistance will be reduced at higher altitudes, which may reduce its damping of the device and also cause the dominant frequency of the eddies to change as the altitude increases, all of which may affect, and be detected, by the sensor device). Also, the output sensitivity of the PZT element may change with the altitude change. After the altitude is sensed by the PZT element in the sensor, the servo motor may use this signal to calculate and/or adjust the dynamic fly height (DFH) of the read/write head.

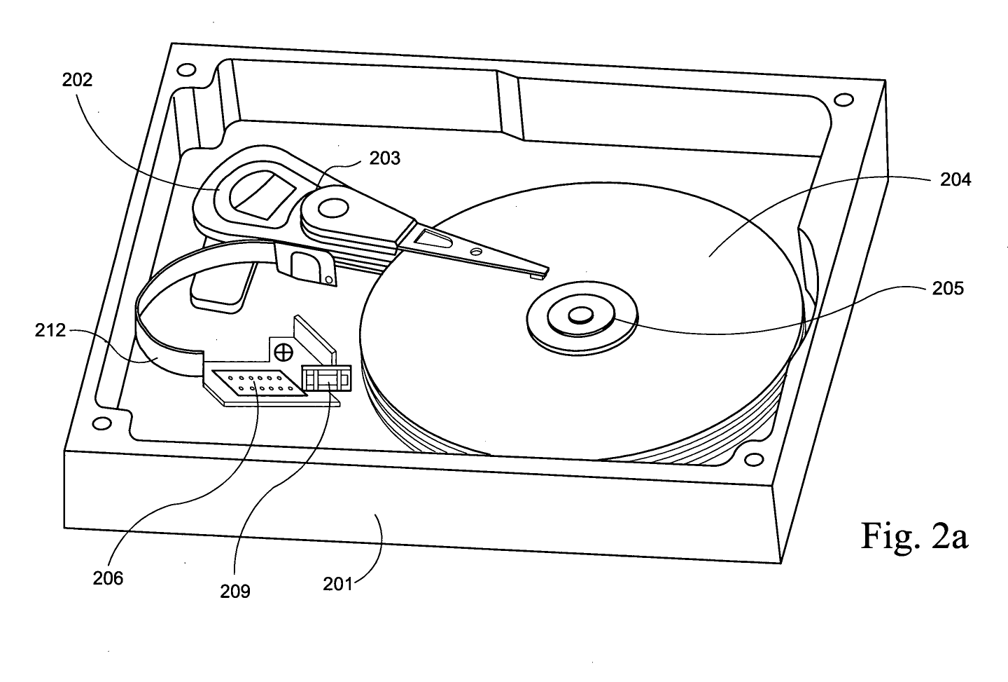

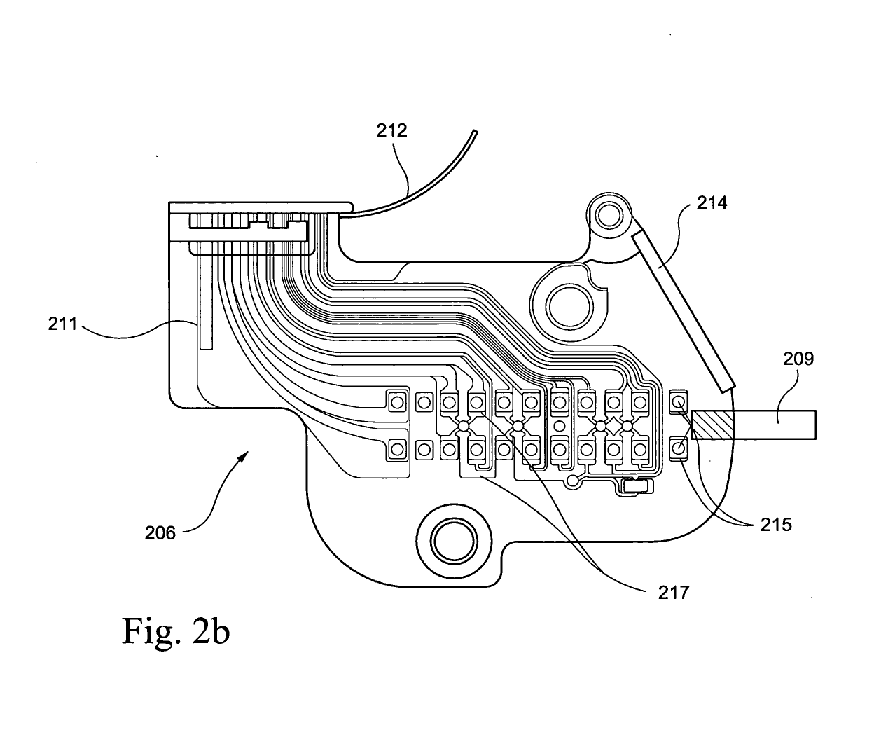

Referring now more particularly to the drawings, FIG. 2a is a hard disk drive (HDD) device having a fly height sensor, in accordance with an example embodiment. The HDD comprises a base 201, and a VCM 202 for controlling the HSA 203. A spindle motor 205 rotates one or more disks 204. A connector 206 operably connects the flex cable 212 of the HSA 203 and a printed circuit board assembly or PCBA (not shown). An altitude sensor 209 for sensing the altitude of the environment also is operably connected to connector 206.

FIG. 2b is a detailed view of the connector 206 of FIG. 2a, in accordance with an example embodiment. The connector comprises a connector support 211, which may be formed from a polymer, nylon, etc. The connector support 211 receives the flex cable 212, and it has a side wall 214 on or near its top edge. Multiple connector pads 217 are operably connected with traces to the flex cable. The altitude sensor 209 is at least partially mounted on the edge of the connector support 211 and close to the end of the side wall 214. This arrangement is advantageous because the air flow at the side of the disk drive can be detected when the spindle is operated. The altitude sensor 209 is operably connected with the connector pads 215. Multiple pins are soldered to the connector pads 215/217 to operably couple the connector pads 215/217 to the PCBA (not shown).

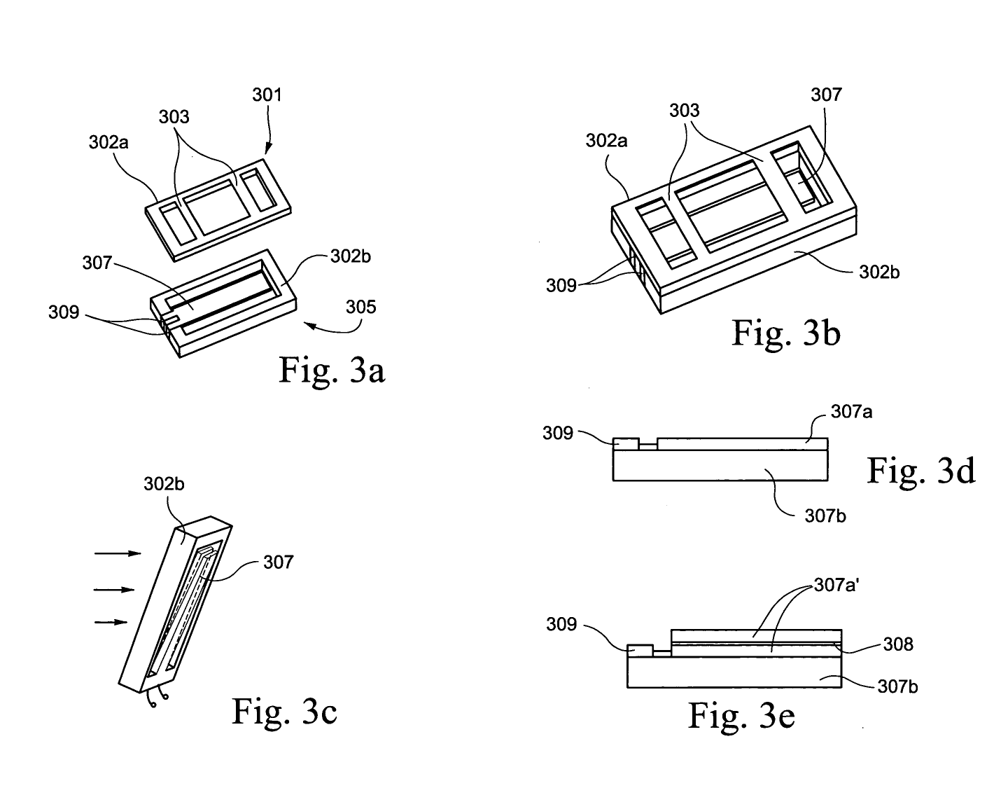

FIG. 3a is a detailed exploded view of a sensor unit, in accordance with an example embodiment. The sensor unit includes a top cover 301 and bottom support 305. The top cover 301 has a frame 302a and two beams 303. The bottom support 305 comprises a frame 302b and a moving beam 307. The moving beam has a PZT layer and a substrate layer. There are two pads 309 at the end of the PZT element for electrical connection. FIG. 3b is a view of the sensor unit of FIG. 3a when assembled, in accordance with an example embodiment.

FIG. 3c illustrates the operational concept of the sensor of FIGS. 3a and 3b. When a force, air current, windage, or the like (as indicated by the arrows) is applied to the sensor unit, the moving beam 309 will deform. Because there is a PZT layer on the surface of the moving beam 309, the PZT element will output a voltage signal when the moving beam 309 deforms.

FIG. 3d is a side view of a first illustrative moving beam 309 of FIGS. 3a-c, in accordance with an example embodiment. The moving beam 309 has a substrate 307b which may be formed from a ceramic (e.g. a silicon or MgO structure), a metal material, etc. There is a PZT layer 307a formed on the substrate beam. In accordance with certain example embodiments, the PZT layer may be a ceramic PZT crystal, a thin-film PZT crystal, or the other suitable material, such as, for example, a PMN-Pt crystal.

FIG. 3e is a side view of a second illustrative moving beam 309 of FIGS. 3a-c, in accordance with an example embodiment. According to this example embodiment, there may be a multilayered PZT element 307a′, sandwiching one or more electrical layers 308. The multilayered PZT element 307a′ may be coupled together and/or to the pads 309 through the electrical layer 308.

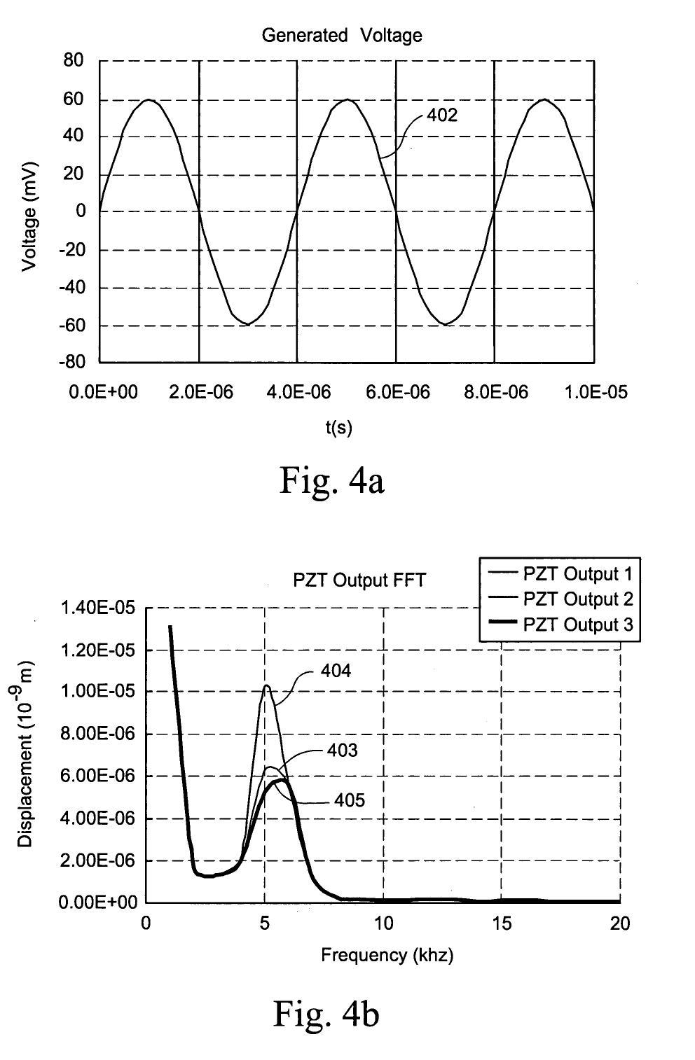

FIGS. 4a and 4b show testing data for an example embodiment. When the HDD is turned on, the sensor will sense the air flow and deform. This deformation will generate a signal output 402. A Fast Fourier Transform (FFT) of the sensor output produces curves 403, 404, and 405, which relate the output and altitude information. Curve 405 corresponds to a normal altitude, curve 403 corresponds to a higher than normal altitude, and curve 404 corresponds to a yet higher altitude. It will be appreciated that other transforms in place of, or in addition to, Fast Fourier Transforms may be used in certain example embodiments.

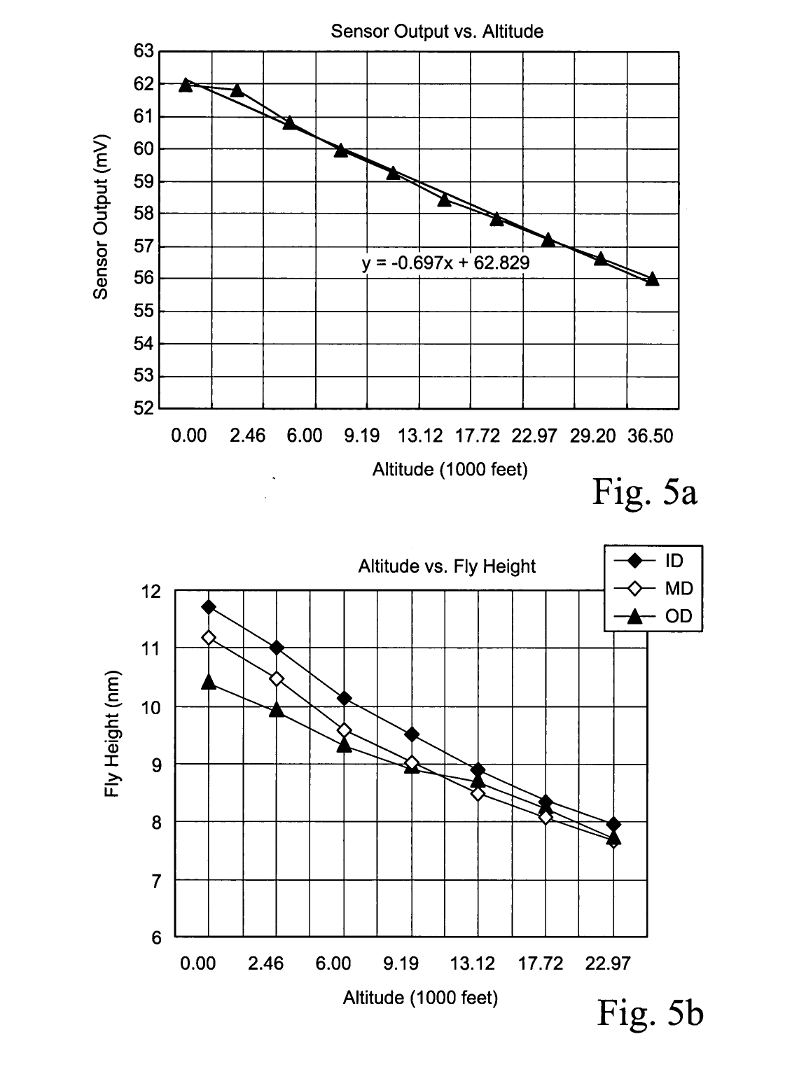

FIG. 5a plots sensor output vs. altitude for a simulation of an example embodiment. Form the chart, it becomes apparent that the sensor output decreases substantially linearly as altitude increases. More particularly, the linear equation that is the best fit to this data is y=−0.697x+62.829. FIG. 5b plots head fly height vs. altitude for another simulation of an example embodiment. The ID, MD, and OD lines represent data for the head laying on the inner, middle, and outer tracks of the disks, respectively. In FIG. 5b, the chart shows the head fly height with ID, MD, and OD track changes when the altitude of the environment changes. As an example, when the altitude of the environment changes from approximately 0 to 22.97 thousand feet, the head fly height reduces approximately 3.5 nm in the MD track. The system should be compensate for or adjust. Otherwise, this change may result in damage to the head-disk interface caused by, for example, the head crashing on the disk.

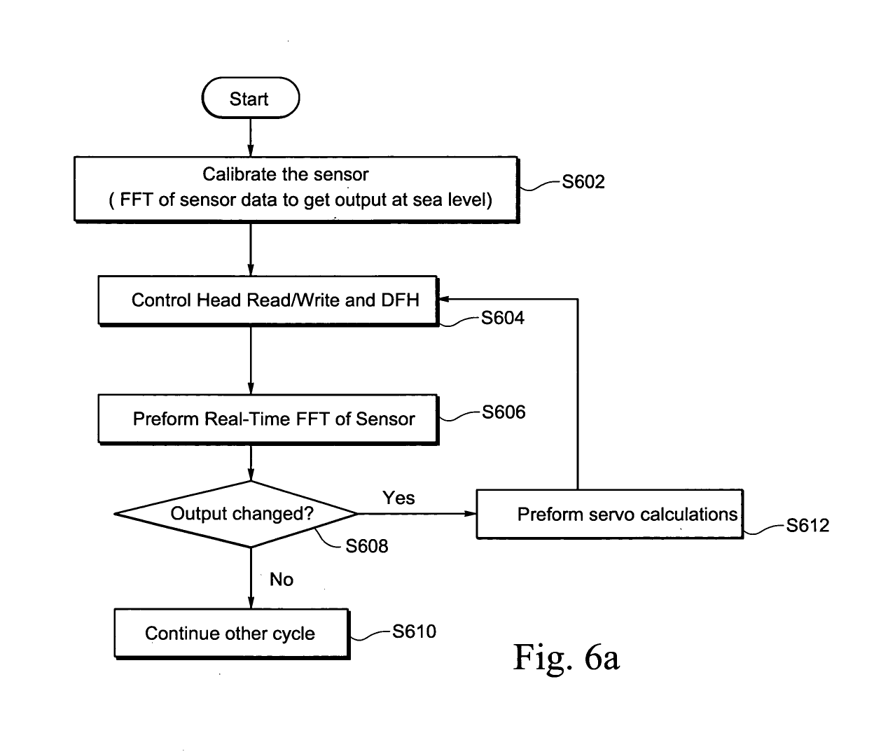

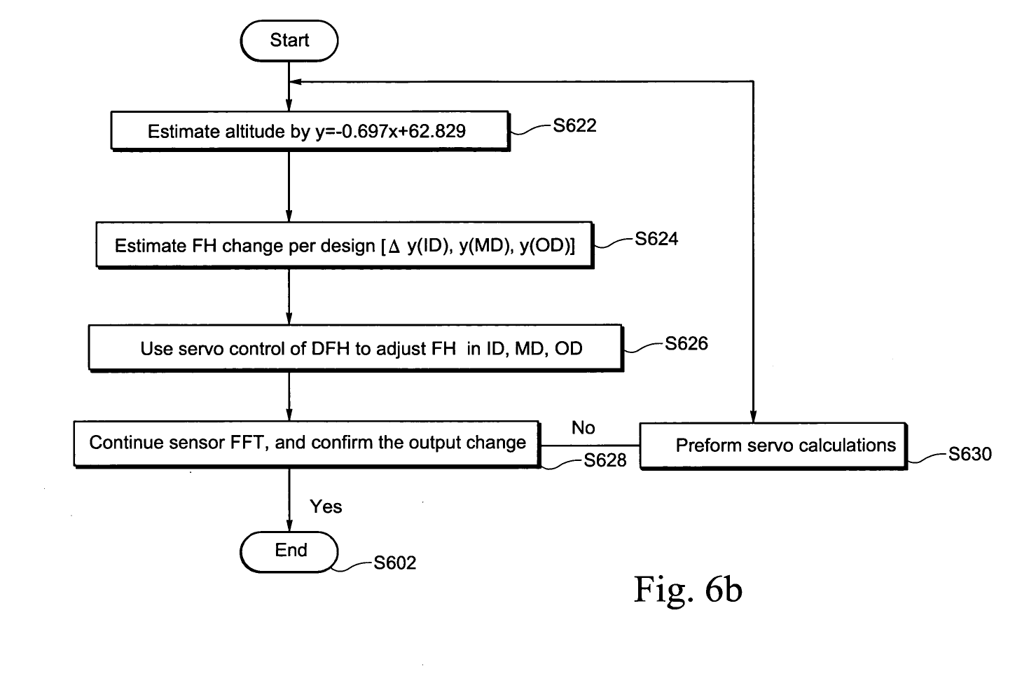

FIG. 6a is an illustrative flowchart showing a process for adjusting the head fly height using the altitude sensor, in accordance with an example embodiment. The sensor is calibrated in step S602 by, for example, performing a FFT on the sensor data to determine the output at sea level. The head read/write process and the dynamic fly height (DFH) is controlled in step S604. In step S606, a real-time FFT is performed on sensor data. Step S608 determines whether the output has changed. If it has not changed, the cycle continues in step S610. However, if the output has changed, servo calculations are performed in step S612, and the process returns to step S604 (wherein the head read/write process and the DFH are controlled).

FIG. 6b is an illustrative flowchart showing a process for calculating how the head fly height should be adjusted, in accordance with an example embodiment. In step S622, the altitude is estimated using the best fit formula, which may be experimentally obtained. In step S624, the fly height change for a particular design is estimated for each disk in the HDD. In step S626, the servo control of the DFH may be used to adjust the fly height for each disk in response to the estimation. In step S628, the sensor data is processed using a FFT, and the change is confirmed. If the change is as expected, the process ends. If the change is not as expected, servo calculations are performed in S630, and the process returns to step S622 (e.g. to re-estimate the altitude, etc.).

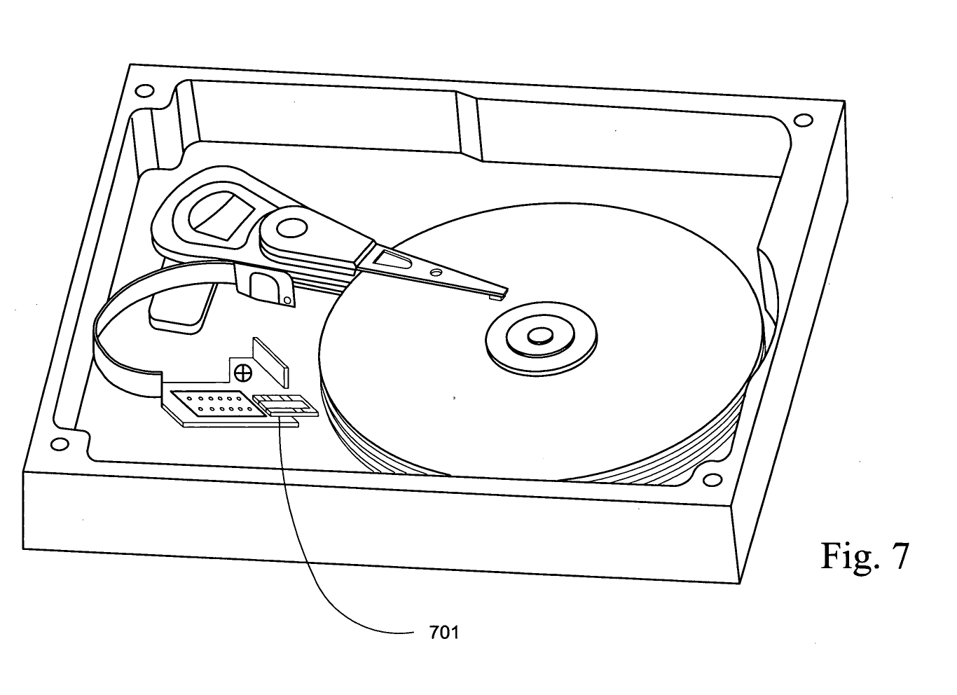

In an alternative example embodiment, the altitude sensor 701 may be laid horizontally as shown in FIG. 7. The moving beam 307 also may be located horizontally when this example configuration is implemented. Alternatively, or in addition, multiple altitude sensors may be stacked (e.g. one altitude sensor may be present for each disk). Descriptions of the other elements of FIG. 7 are omitted to avoid confusion.

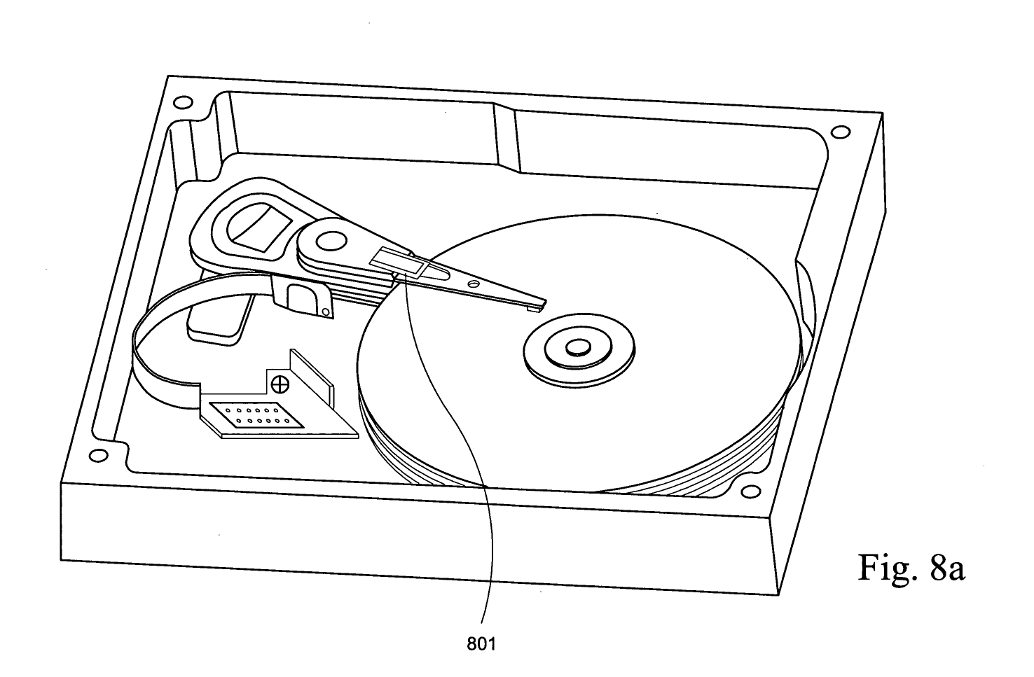

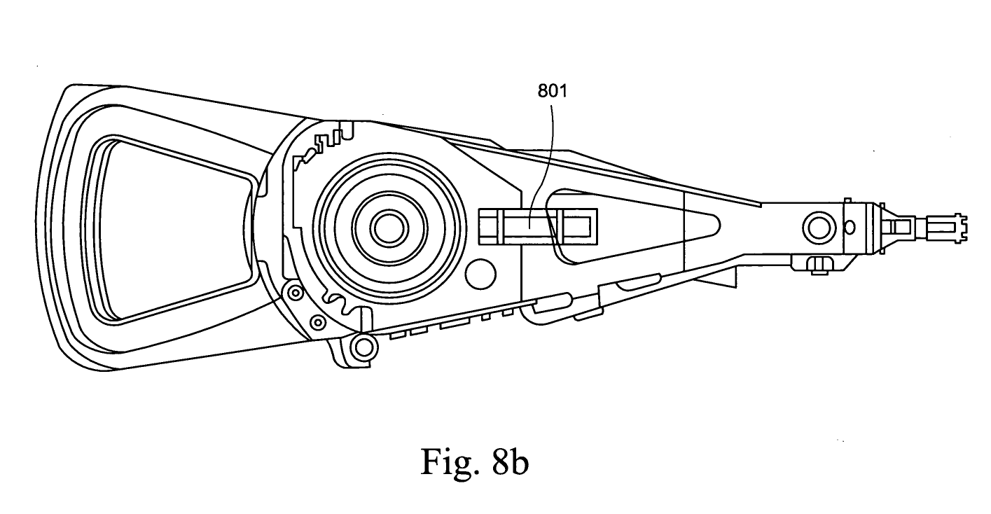

In another example embodiment, the altitude sensor 801 also may be mounted to the top surface of the arm of the VCM, as shown in FIG. 8a. The sensor 801 will sense the air flow from the disk and generate signals in a manner similar to those set forth with respect the example embodiments described above. FIG. 8b is a detailed view of the arm of FIG. 8a. Alternatively, or in addition, an altitude sensor 801 may be mounted on top of each arm in the HSA.

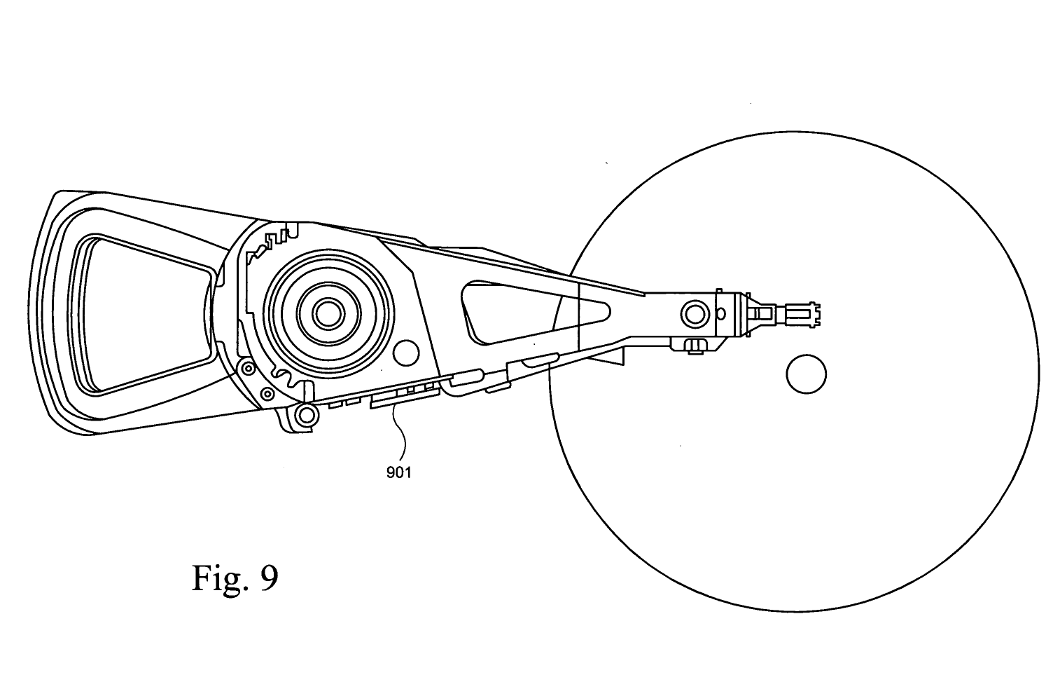

FIG. 9 is yet another example embodiment in which the altitude sensor 901 is mounted to the side of the VCM arm. In particular, sensor 901 is on the side of the arm proximate to a pre-amplifier. A trace (not shown) from the flex cable may be used for operably connecting the sensor to the servo controller.

It will be appreciated that the above simulations and experiments are given by way of example and without limitation. Other data from other simulations and/or experiments may yield different results potentially affecting, for example, the best fit equation (e.g. in terms of coefficients, linearity, etc.), heights at which problems may be expected, etc. Indeed, other experiments may yield data and/or best fit equations better suited for the example embodiments described with reference to FIGS. 7-9.

Also, it will be appreciated that any type of PZT element may be used in connection with the example embodiments described herein. By way of example and without limitation, such PZT elements may be ceramic PZTs, thin-film PZTs, PMN-Pt PZTs, etc.

Although certain example embodiments have been described as relating to sensor units that may be disposed within disk drive devices, the present invention is not so limited. For example, certain example embodiments may provide an altitude sensor for use in any device and/or system for any industry or field in which it is desirable to sense windage and/or to define the related altitude and/or altitude changes. In certain of such example embodiments, the sensor may be located proximate to the windage region, and/or at the edge of a side wall that may direct the air flow of the windage towards the sensor.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. An altitude sensor configured to detect an air flow windage generated by a component of a system, comprising:
a beam configured to move in response to the air flow windage;
at least one PZT layer formed on a surface of the beam, the at least one PZT layer being configured to generate a voltage corresponding to a movement of the beam; and,
at least one connection pad operably coupled to the at least one PZT layer, the at least one connection pad being suitable for outputting the voltage,
wherein the air flow windage is related to altitude.

2. The fly height sensor of claim 1, further comprising two PZT layers disposed around an electrical connection layer, the electrical connection layer being coupled to the at least one connection pad.

3. The altitude sensor of claim 1, wherein the beam comprises a substrate layer formed from a ceramic and/or a metal.

4. The altitude sensor of claim 1, further comprising:
a top cover having a frame and two support beams; and,
a bottom support having a frame,
wherein the beam is formed on and/or attached to the bottom support.

5. An altitude sensor for use in a disk drive device, comprising:
a beam configured to move in response to an air flow generated by a rotating disk;
at least one PZT layer formed on a surface of the beam, the at least one PZT layer being configured to generate a voltage corresponding to a movement of the beam; and,
at least one connection pad operably coupled to the at least one PZT layer, the at least one connection pad being suitable for outputting the voltage.

6. The altitude sensor of claim 5, further comprising two PZT layers disposed around an electrical connection layer, the electrical connection layer being coupled to the at least one connection pad.

7. The altitude sensor of claim 5, wherein the beam comprises a substrate layer formed from a ceramic and/or a metal.

8. The altitude sensor of claim 5, further comprising:
a top cover having a frame and two support beams; and,
a bottom support having a frame,
wherein the beam is formed on and/or attached to the bottom support.

9. The altitude sensor of claim 5, further comprising a processor configured to determine a fly height of a head over the disk appropriate at a given altitude, a dynamic fly height of the head over the disk, and an adjustment amount corresponding to the difference between the fly height and the dynamic fly height.

10. A disk drive device, comprising:
a head gimbal assembly;
a drive arm connected to the head gimbal assembly, the head gimbal assembly including a slider having a read/write head formed thereon;
a disk;
a spindle motor operable to spin the disk, the disk causing an air flow when spun; and,
an altitude sensor for head fly height adjustment, the altitude sensor including:
a beam configured to move in response to the air flow;
at least one PZT layer formed on a surface of the beam, the at least one PZT layer being configured to generate a voltage corresponding to a movement of the beam; and,
at least one connection pad operably coupled to the at least one PZT layer, the at least one connection pad being suitable for outputting the voltage.

11. The disk drive device of claim 10, further comprising a processor configured to determine a fly height of the head over the disk appropriate at a given altitude, a dynamic fly height of the head over the disk, and an adjustment amount corresponding to the difference between the fly height and the dynamic fly height.

12. The disk drive device of claim 11, further comprising a flex cable operably connecting the fly height sensor and the processor.

13. The disk drive device of claim 11, further comprising a servo motor operable to adjust the dynamic fly height of the head in response to the adjustment amount.

14. The disk drive device of claim 11, wherein the processor calculates altitude according to a formula, the formula being y=−0.697x+62.829, wherein y is the sensor output in millivolts and x is the altitude in thousands of feet.

15. The disk drive device of claim 10, wherein the fly height sensor is located proximate to the disk and proximate to a side of the drive.

16. The disk drive device of claim 10, wherein the fly height sensor is located on top of the head gimbal assembly.

17. The disk drive device of claim 10, wherein the fly height sensor is located on a side of the head gimbal assembly.

18. A method of determining dynamic fly height of a read/write head flying over a disk, the method comprising:
generating a signal corresponding to air flow caused by rotation of the disk; and,
associating the signal with a dynamic fly height based at least in part on an altitude of the read/write head.

19. The method of claim 18, wherein the signal and the fly height are associated using a Fast Fourier Transform.

20. The method of claim 18, further comprising estimating the altitude according to a formula, the formula being y=−0.697x+62.829, wherein y is the signal in millivolts and x is the altitude in thousands of feet.

21. The method of claim 18, further comprising changing the dynamic fly height based at least in part on the altitude.
